(19) United States
(12) Patent Application Publication
(10) Pub. No.: US 2026/0001177 A1
(43) Pub. Date: Jan. 1, 2026

(54) SCREWDRIVING TOOL HEAD, SCREWDRIVING TOOL, METHOD FOR SCREWING IN A SCREW USING THE SCREWDRIVING TOOL, AND COMPUTER PROGRAM

(71) Applicant: Rolls-Royce Solutions GmbH, Friedrichshafen (DE)

(72) Inventor: Kai Kortkamp, Friedrichshafen (DE)

(73) Assignee: Rolls-Royce Solutions GmbH, Friedrichshafen (DE)

(21) Appl. No.: 19/319,064

(22) Filed: Sep. 4, 2025

Related U.S. Application Data
(63) Continuation of application No. PCT/EP2024/054969, filed on Feb. 27, 2024.

(30) Foreign Application Priority Data
Mar. 7, 2023 (DE) 10 2023 105 629.8
Feb. 27, 2024 (WO) PCT/EP2024/054969

(51) Int. Cl. B23P 19/06; G01B 21/16

(52) U.S. Cl. CPC B23P 19/069; G01B 21/16

(57) ABSTRACT

A screwdriving tool head includes:
a measuring attachment;
a measuring device, wherein:
   (a) the measuring attachment is for a distance measurement and is attached to a spindle between drive and head sides; and
      the measuring device is for the distance measurement and interacting with the measuring attachment and is mounted to a reference structure between the head side of the spindle and the measuring attachment; or
   (b) the measuring device is for the distance measurement and is mounted on the spindle between the drive side and the head side; and
      the measuring attachment is for the distance measurement and interacting with the measuring device, and is mounted to the reference structure between the head side and the measuring device; and
a spacer element, which is in addition to the reference structure or is formed with the reference structure, the spacer element being configured for being placed on a screw base.

### CROSS REFERENCE TO RELATED APPLICATIONS

This is a continuation of PCT application no. PCT/EP2024/054969, entitled “SCREWING TOOL HEAD, SCREWING TOOL, METHOD FOR SCREWING IN A SCREW USING THE SCREWING TOOL, AND COMPUTER PROGRAM PRODUCT”, filed Feb. 27, 2024, which is incorporated herein by reference. PCT application no. PCT/EP2024/054969 claims priority to German patent application no. 10 2023 105 629.8, filed Mar. 7, 2023, which is incorporated herein by reference.

### BACKGROUND OF THE INVENTION

### 1. Field of the Invention

The present invention relates to a screwdriving tool head.

### 2. Description of the Related Art

Screwdriving tools, in particular automatic screwdriving machines or similar partially or fully automated screwdriving tools, with a screwdriving tool head are known in principle, and a general mode of operation is described for example in EP 0 600 285 A1.

DE 10 2011 121 923 A1 describes a distance measuring device for an automated screwdriving machine acting, in a horizontal plane, wherein the automated screwdriving machine has a chassis for the horizontal plane which can be moved by way of wheels or rollers and on which at least one magazine is arranged to accommodate fastening elements, wherein respectively one fastening element or individual elements that are fed together are separated from the respective magazine stream by the lifting movement of a vertically movable screwdriver that is arranged on the chassis, and is positioned and screwed in in the screw-in axis.

EP 0 798 449 A1 shows a screwdriving tool head referred to at the beginning, which serves as part of an adjusting device for setting the relative angle position of a driven camshaft of an internal combustion engine. This includes a controlled, displaceable adjusting element that is connected to the camshaft in a rotationally fixed manner via gear teeth of a drive gear and that is assigned to a stop of the adjusting device in a machine reference position. For the precise rotational position assignment of the adjusting device to the camshaft during assembly, a signaling device indicating the retarded stop position of the adjusting element at the stop is provided in an assembly-dependent reference position of the internal combustion engine.

Procedures are used for total or partial screwing in of a screw or screw-type elements, generally with stationary screwdriving tools in a production chain. Special care must be taken in this process; in general, with any type of automated screwing in of a screw, care must be taken to ensure that the process is implemented and completed in accordance with the specifications and without damaging the screw.

In the case of torque screw connections, the tightening torque can be used to a certain extent to check adherence to all specifications for the screw-in process; in the case of angle of rotation controlled screw connections—such as the one in EP 0 798 449 A1—a cumulative angle of rotation is used to check that the screw connection is reliable.

However, the latter procedure is especially problematic if the attachment of the screwdriving way to the screw head is incomplete. Slipping, for example, of sockets on electrically driven screwdriving spindles, can then occur when tightening screws or nuts. Below, these and others are generally referred to collectively as screw heads. In order to prevent sockets from slipping off, an attempt is usually made to support so-called overreacting of the sockets via the rotary movement of the screwdriving spindles (also under the name “thread-on process” or “locating stage”) in the screwdriving program. There are also chamfers on screw nuts or specially shaped “surface drive” nuts that should make this easier.

For example, DE 10 2005 014 901 A1 describes a pneumatic screwdriving system with a screwdriving device which is attached to a bracket and which contains a screwdriving tool that can be moved back and forth in a screwdriver channel between a retracted starting position and an advanced screwdriving position, with a screw feeding device with a magazine from which one screw is fed at a time into the screwdriver channel, and with a work table on which a workpiece into which the screw can be driven can be attached, and with a torque detection device, wherein the screwdriving device has a position measuring device which captures the distance traveled by the screwdriving tool to the end of the screwdriving process, wherein the screwdriving device includes another measuring device which records the position of the upper edge of the workpiece.

However, the aforementioned measures cannot ensure that the screwdriving way is sufficiently applied to the screw head. Monitoring and detection of an error-prone screwing process can usually no longer prevent damage to the screw head.

Despite the known measures and depending on the specific application and system design, screw heads are still occasionally damaged due to slipping. This can occur especially in all automated screwdriving processes with higher torques. However, it can happen that the socket slips off with increasing torque, leaving the screw standing. With tightening angles of rotation (a screw connection specification herein is not a final torque, but a final angle)—especially with high rotational angle specifications of approx. 180°—it can also happen that—for example with hexagon head screws beyond 60°—the socket threads itself back on again due to a slow final stage speed, takes the screw with it and then simulates a good end result.

If this is not otherwise discovered, this can have fatal consequences for the (often demanding rotation angle) screw connection.

Such instances could be avoided with reliable recognition that the nut is correctly joined.

What is needed in the art is in a first aspect a screwdriving tool head and a screwdriving tool by way of which a sufficient attachment of the screwdriving way to the screw head can be ensured, in particular in such a way that the screwdriving way joins effectively with the screw head, optionally so that the attachment of the screwdriving way to the screw head is complete or at least sufficient for the required power transmission.

What is also needed in the art is a method for screwing in a screw in a second aspect.

### SUMMARY OF THE INVENTION

The present invention relates to a screwdriving tool head according to the generic term of claim 1. A screwdriving tool head of includes at least one spindle unit which is designed to accommodate a screwdriving way to screw in a screw or a similar screw element, wherein the screwdriving tool head is designed for installation in a screwdriving tool in particular an automated screwdriving machine, and wherein the spindle unit includes:
a spindle arranged axially relative to the spindle unit with a drive side and a head side, wherein the spindle can be coupled on the drive side to an output unit of the automated screwdriving machine and is designed to be rotatable above it, and the screwdriving way can be accommodated on the head side of the spindle for application to a screw head of the screw,
a reference structure which extends at least partially along the spindle unit, which is movable axially relative to the spindle and which is held on the spindle unit and is rotatable relative to the spindle.

The present invention also relates to a screwdriving tool, in particular an automated screwdriving machine or a similar partially or fully automatic screwdriving tool, with a screwdriving tool head of the type referred to above, as well as to a method for screwing in a screw with a screwdriving tool and a computer program product designed to carry out the method for screwing in a screw with a screwdriving tool.

Accordingly, the present invention is based on a screwdriving tool head with at least one spindle unit, which is designed to accommodate a screwdriving way for screwing in a screw or similar screw element, wherein the screwdriving tool head is designed for installation in a screwdriving tool, in particular an automated screwdriving machine. The spindle includes:
a spindle arranged axially with respect to the spindle unit with a drive side and a head side, wherein the spindle can be coupled to an output unit of the automated screwdriver on the drive side and is designed to be rotatable above it, and the screwdriving way can be accommodated on the head side of the spindle for attachment to a screw head of the screw,
a reference structure which extends at least partially along the spindle unit, which is movable axially with respect to the spindle and which is held on the spindle unit and can be rotated relative to the spindle.

According to the present invention it is provided that:
a measuring attachment designed for distance measurement is attached to the spindle between the drive side and the head side, and
a measuring device designed for distance measurement and interacting with the measuring attachment is attached to the reference structure between the head side of the spindle and the measuring attachment.

In an alternative variation, the concept of the present invention includes that (conversely) attached to the spindle, a measuring device designed for distance measurement is arranged between the drive side and the head side, and attached to the reference structure a measuring attachment is arranged between the head side of the spindle and the measuring device for distance measurement and interaction with the measuring device.

In principle, the variations can also be combined. A distance measurement occurs in that the measuring device interacts with the measuring attachment. This means that the measuring device has physical ways that are able to specify a distance in the sense of a distance between the measuring device and the measuring attachment, in particular to indicate the distance in the sense of a distance between the measuring device and the measuring attachment set in relation to each other.

According to the present invention the spindle unit includes the following:
an additional spacer element to the reference structure or one formed with the reference structure, wherein the spacer element is designed to be placed on a screw base.

The wording “in a joint state” also includes that the screwdriving way accommodated on the head-side of the spindle is at least in a sufficiently joint state with the screw head. In particular, it is intended to mean that the joint state is sufficient to provide a complete force-transmitting form fit between the screwdriving way and the screw head in this state of complete or partial but sufficient joining, which can withstand an optimized or optimal to maximum torque.

The screwdriving tool head according to the present invention ensures with the design of the spindle unit that, when the screwdriving way is in a sufficient joint state with the screw head (that is, optionally complete or sufficient partial joining so that a screwdriving process can be safely completed), this is recognizable or is recognizable if this is not the case.

In a first aspect, the invention also refers to a screwdriving tool, in particular an automated screwdriving machine or a similar partially or fully automated screwdriving tool, with a screwdriving tool head according to the concept of the present invention, that is, a tool of the aforementioned type, and with a screwdriver drive to drive at least one spindle of the screwdriving tool head. The present invention provides according to the second aspect a method of screwing in a screw; the method is intended to use the screwdriving tool according to the first aspect of the invention.

According to the present invention, the method includes the following steps:
optional screwing in of the screw up to a protrusion dimension,
threading the screw, if possible in such a way that, with an additional spacer element or a spacer element formed with the reference structure, optionally in the embodiment of a cage, the screwdriving way accommodated on the head side of the spindle is positioned on the screw head in such a way that it is in contact with the screw head,
checking whether the screwdriving way is in a joint state with the screw head by way of the measuring device attached to the reference structure designed for distance measurement and interacting with the measuring attachment attached to the spindle, OR
checking whether the screwdriving way is in a joint state with the screw head by way of the measuring attachment designed for distance measurement and interacting with the measuring device attached to the spindle attached to the reference structure,
Screwing in the screw with the screwdriving tool.

Optionally, screwing in the screw occurs only if the distance measurement confirms that the screwdriving way that is accommodated on the head side of the spindle is in a joint state with the screw head.

According to the second aspect, the present invention also provides a computer program product designed to carry out the method for screwing in a screw with a screwdriving tool according to the present invention when the computer program product is implemented on the screwdriving tool.

In simple terms, the present invention conceptually offers an improved metrological system by way of which the relative height of the screw spindle, or for example the socket, to the screwed component can be measured. However, the metrological system of the present invention also avoids, in an improved manner, uncertainties regarding variances and changes in the screwdriving way and on the screw head.

Conceptually, the present invention offers an improved metrological system. For this purpose, a measuring attachment designed for distance measurement is mounted to the spindle between the drive side and the head side, and a measuring device designed for distance measurement and interacting with the measuring attachment is mounted to the reference structure between the head side of the spindle and the measuring attachment. The measuring attachment and the interacting measuring device can also be arranged in reverse; in other words, the measuring attachment is mounted on the reference structure and the measuring device is mounted on the spindle.

In this respect, the distance measurement only uses defined reference points, namely spindle and reference structure, however, not directly the screwdriving way and screw heads which are affected by variances; variances in the screw base are also minimized to a certain extent.

The present invention proposes a way, generally referred to as a spacer element, for continuing the reference structure, which can be specially designed.

This means that the spindle unit is free of variances and reliably designed, so that when the spacer element is placed, the screwdriving way that is accommodated on the head side of the spindle can attach to the screw head in such a way that it is in a joint state with the screw head, whereby it can be recognized by way of the distance measurement that the screwdriving way is in in a joint state with the screw head.

The spindle unit is advantageously designed in such a way that when the spacer element is placed the screwdriving way accommodated on the head side of the spindle can be applied to the screw head in such a way that it is in a joint state with the screw head.

It is advantageously provided that it is recognizable by way of the distance measurement whether the screwdriving way is in a joint state with the screw head.

The spacer element to the reference structure can optionally be held on and/or with a stop to the reference structure and by the reference structure.

Optionally, the spacer element is designed to surround the head side and the screwdriving way, wherein the spacer element is moreover designed to be placed on a screw base. The spacer element can thus be understood as distal end of the reference structure and, in an advantageous further development, can also be designed, for example, integrally with the reference structure; in this respect, a further development of the invention fundamentally includes diverse possibilities for designing the spacer element on and/or with a stop to the reference structure and held by the reference structure.

It is advantageously provided that:
the spacer element is provided and/or designed as a distance-maintaining element between the screw base and the reference structure, and/or
the spacer element is held on and/or with a stop to the reference structure and by the reference structure.

It is advantageously provided that the spacer element has one or a number of elements which are selected from a group of individual elements, or elements arranged in pairs, consisting of: a plate, a finger, a pin, a tube, a cage, in particular wherein the tube and/or cage is designed to surround the head side and the screwdriving way.

It is advantageously provided that the reference structure is designed as a sleeve, extending off-axis of the spindle unit and surrounding the spindle, which extends off-axis of the spindle unit and surrounds the spindle, in particular wherein the spacer element in the embodiment of a tube and/or the cage connects with the sleeve and is designed to surround the head side and the screwdriving way.

It is advantageously provided that the spacer element placed on a screw base with a stop to the reference structure is designed to move the reference structure axially and relative to the spindle, wherein a relative displacement path between the reference structure and the spindle is detected by the measuring device interacting with the measuring attachment.

The additional spacer element or the spacer element designed with the reference structure is especially advantageous, but not necessarily in the embodiment of a cage. The reference structure is especially advantageous, but not necessarily, in the embodiment of a sleeve, advantageously as a sleeve extending off-axis of the spindle unit and surrounding the spindle. The spacer element and the reference structure can also merge into one another into one piece or be designed integrally as a single component.

According to the aforementioned characteristic, the spindle unit advantageously includes:
a cage for the sleeve extending off-axis from the spindle unit and surrounding the spindle, wherein the cage is designed to be placed on a screw base. Advantageously, the cage can simply represent a section of the sleeve.

It is advantageously provided that—analogous to the spacer element and the reference structure—the placed cage (or generally a spacer element) is designed with a stop to the sleeve (or generally to the reference structure) and is held by the sleeve for moving the sleeve axially and relative to the spindle, wherein a relative displacement path between the sleeve and the spindle is detected by the measuring device interacting with the measuring attachment.

It is advantageously provided that the distance measurement is designed, in particular by way of a relative displacement path between the sleeve and the spindle, to specify a distance dimension wherein the distance dimension relative to a distance threshold value indicates that the screwdriving way is in a joint state with the screw head.

The improved metrological system of the present invention is basically capable in an improved manner of comparing a distance dimension obtained by way of distance measurement with established target values in an advantageous and reliable manner, in particular by avoiding hitherto existing variances.

It is advantageously provided that:
the measuring attachment is designed as a measuring disk around the spindle, and/or
the measuring device is a non-contact measuring device, in particular for detecting a measuring pulse time or a phase-sensitive measuring signal between the measuring attachment and the measuring device, optionally a measuring device based on a light signal, a radio signal or similar electromagnetic measuring signal or an acoustic measuring signal between the measuring attachment and the measuring device.

It is advantageously provided that the measuring attachment and the measuring device are arranged along a distance measuring section extending axially along the spindle unit, in particular wherein the measuring section extends along the spindle between an upper end of the sleeve and the drive side.

A further development advantageously provides for a calibration ring for the screwdriving tool head, which is held with a stop to the sleeve and by the sleeve, and which is designed to surround the head side and the screwdriving way, wherein the calibration ring is further designed to be placed on a screw base, wherein the calibration distance set by the calibration ring for moving the sleeve axially and relative to the spindle is known and is determinable.

It is advantageously provided that the spindle and/or the sleeve is spring-mounted, in particular spring-loaded. Instead of spring-loaded mounting, a weight force acting in screwdriving direction can also be used, that is the weight force of the spindle and/or the reference structure, in particular a sleeve.

It is advantageously provided that the measuring device is designed to transmit and/or receive an evaluation and/or information signal, wherein the evaluation and/or information signal contains one or a series of the specification or evaluation information selected from the group of specification or evaluation information consisting of: an offset value for a screw head of a screw, in particular a screw head with a collar, a tolerance value for a screw head of a screw, a protrusion value for a protrusion of a screw head relative to the screw base, a calibration distance for moving the sleeve axially and relative to the spindle, and a distance threshold value indicating that the screwdriving way attaches to the screw head.

In particular, the fact that the position and height of the screw head is usually known can also be utilized. It can also be used to calculate how far the socket is fitted over the screw head, and thus ultimately how far the output geometry of the socket is engaged with the drive geometry of the screw. If this covering is too small, it is not sufficient for a smooth and non-destructive introduction of the screwdriving torques.

Ideally, especially with regard to the method, with electronically controlled screwdriving systems, the detection stage is automatically repeated until the overlap is sufficient. To prevent endless loops in the event of mechanical defects or similar issues, a fixed detection duration should be specified. If this is exceeded a fault could be triggered.

It is advantageously provided that a measurement evaluation unit is designed to capture one or a number of the evaluation variables, which are selected from the group of evaluation variables consisting of: a number of confirmed and/or non-confirmed threading processes in which the screwdriving way that is accommodated on the head side of the spindle applies to the screw head, in particular so that it is in a joint state with the screw head; one or more threshold values for the number of threading processes and/or for a time span of a threading process.

It is advantageously provided that the screwdriving tool head is designed as a double screwdriving tool head, wherein the spindle unit is formed as a first spindle unit, and a second spindle unit is formed analogously to the spindle unit.

It is advantageously provided that the screwdriving tool head is designed as a double screwdriving tool head with a first and a second spindle unit, and the screwdriver drive has an output with a first output unit for driving a first spindle of the first spindle unit and with a second output unit for driving a second spindle of the second spindle unit.

It is advantageously provided that the screwdriver drive is designed to implement the drive of the first and second spindles synchronized with each other and with opposite directions of rotation by way of the output.

Embodiments of the invention are described below with reference to the drawings in comparison to the state of the art, some of which are also shown. These are not necessarily intended to be to scale, but, where useful for explanation, the drawings are schematic and/or slightly distorted. With regard to additions to the teachings immediately apparent from the drawings, reference is made to the relevant state of the art. It should be considered that numerous modifications and changes regarding the design and detail of an embodiment can be made without deviating from the general idea of the invention. The features of the invention disclosed in the description, the drawings and the claims can be essential, both individually and in any combination for further development of the invention. Moreover, all combinations of at least two of the features disclosed in the description, the drawings and/or the claims are within the scope of the invention.

The general idea of the invention is not limited to the exact form or detail of any optional embodiment shown and described below or limited to an object that would be limited compared to the object claimed in the claims. In the case of specified measurement ranges, values within the stated limits are also intended to be disclosed as limit values and can be used and claimed as desired. Additional advantages, features, and details of the invention become apparent from the following description of the optional embodiments and from the drawings.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1A is an exemplary representation of screws with damaged screw heads as a result of the failure of a screwing-in operation due to an insufficiently joint state of screwdriving way of a socket on the screw head;

FIG. 1B is an exemplary screw progression as a screwing force or torque progression over angle of rotation with an event leading to damage to a screw head due to a socket slipping off and being re-applied onto the screw head;

FIG. 2 is a basic schematic diagram concerning the situation on a screwdriving tool, such as an automatic screwdriving machine, wherein the screwdriving way being applied to the screw head is checked by way of a distance measurement, wherein the alternative presented here is particularly advantageously suitable for a simple, advantageously hand-held, screwdriving tool;

FIG. 3 is a schematic representation of the situation on an advantageously stationary screwdriving tool, such as an automatic screwdriving machine or similar screwdriving tool in accordance with an optional embodiment of a screwdriving tool head, by way of which it can be seen in an even more advantageous distance measurement than the above-mentioned alternative in FIG. 2 whether the screwdriving way is in a joint state with the screw head;

FIG. 4 is a detailed representation of a screwdriving tool head according to a second optional embodiment for installation in an automatic screwdriving machine or similar screwdriving tool;

FIG. 5 is a perspective view of the underside of the screwdriving tool head onto its sleeve and socket as the screwdriving way on a spindle;

FIG. 6 is a lateral perspective view of the screwdriving tool head of FIGS. 4 and 5 according to the optional design example;

FIG. 7 is a lateral perspective view of a detail of the sleeve and the socket and the spindle on the screw base for the design example of FIG. 6; and

FIG. 8 is a flow diagram of a basic sequence of a method for screwing in a screw with a screwdriving tool according to the concept of the invention, namely in particular according to an embodiment as shown in FIG. 3 to FIG. 7.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

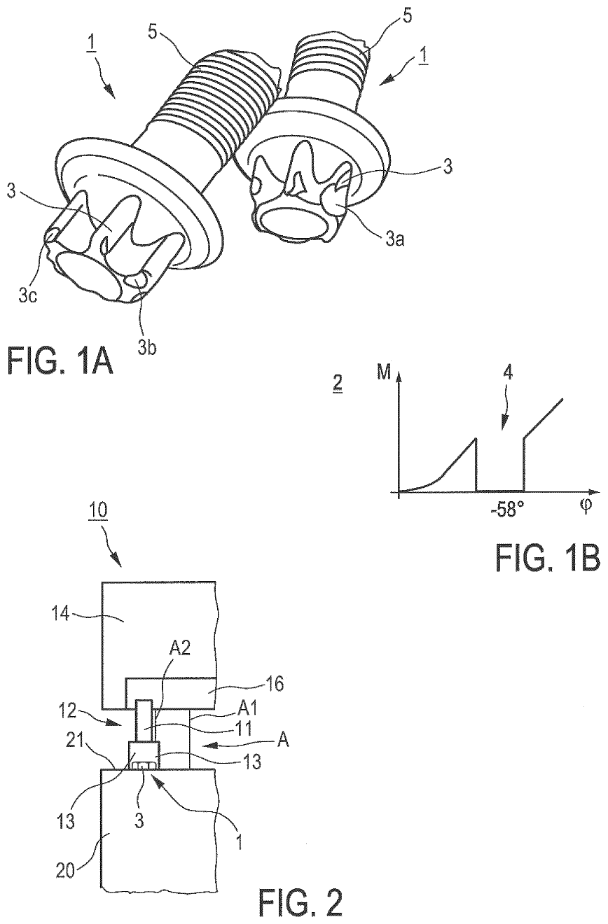

Applying a socket to a screw head 3 of a screw 1 shown in FIG. 1A is usually performed by way of a so-called threading process at the beginning of the screwing-in process of screw 1 with its thread 5 into a screw hole. Depending on the condition of screw head 3 and of the matching socket and a number of other factors, the situation could arise that the socket does not achieve a joint state with screw head 3.

Factors include, for example: axial alignment between spindle and screw axis;
alignment of the screw location (vertical/angled/horizontal); distance between the spindle output and the socket; wear on the square end of the socket or spindle output; wear and/or
contamination on the socket output; tolerances in all of the above; in particular, any combination of the above factors.

However, as recognized by the present invention, the most essential of these factors are overcome, and the screwdriving tool head according to the concept of the present invention supports a reliable screwing process, in which it is ensured beforehand reliably and in an advantageous manner compared to hitherto known measures that a screwdriving way (such as the socket) is in a joint state with a screw head. This is certainly an important-to-necessary prerequisite that should be met before starting a screwdriving process in order to be able to screw in the screw efficiently and without interruption, that is, above all, successfully and without damaging the screw, until completion.

At best, it may be sufficient to abort the screwing process in order to leave the screw undamaged, even if the screwdriving way, such as the socket used here as an example, is applied to the screw head but is not or only partially is in a joint state with it. However, it is unlikely that the screwing process can be completed until the screw is fully tightened, in other words, until the screw is fully installed, or that the screw remains undamaged.

Screws 1 shown as examples in FIG. 1A are the result of a less favorable case in which screw head 3 is damaged in the course of the screwing process, that is, specifically the screwing-in process. Screw head 3 can be seen to be crushed, pitted or similarly damaged 3a, 3b, 3c.

These damages 3a, 3b, 3c may make it impossible to reapply the screwdriving way such as the socket in the event of an interrupted screwdriving process, so that further installation of the screw, but certainly loosening of the screw, is made difficult or impossible.

If the socket or a similar screw driving device fails or if screw head 3 fails due to damage 3a, 3b, 3c, this can lead to a disruption of the entire production process and even to a plant shutdown.

Frequently, the consequence is that a corresponding screw 1 on the object to which it is to be screwed, such as an engine or a complex drive unit such as a generator, a genset, a fuel cell or other parts of a propulsion system or an internal combustion engine, must be interrupted, and the last screw(s) installed, or all previous screws and screwdriving processes must be checked or replaced. For this reason, it is also desirable that there is an increased safety measure in place regarding the above problem prior to a screwdriving process.

FIG. 1B shows an example of a screwdriving progression 2 recorded in an automatic screwdriving machine during monitoring of the screwdriving process when screwing in a screw 1. Screwdriving progression 2 is shown as a function of torque M on the screwdriving tool and angle φ as the angle of rotation of the screwdriving way, for example the socket. It is apparent that the characteristic progression of torque M over the angle of rotation φ—in other words, the progression of screwdriving progression 2—has a torque M increasing with the angle of rotation φ during the screwing-in process. The fact that the torque now abruptly declines at the angle of rotation of about 58°, deviating from the characteristic progression, is the result of the socket slipping off screw head 3. However, the screwdriver socket threads itself back onto hexagonal screw head 3 shown here in FIG. 1A to complete the screw tightening process; deviating from the characteristic progression, the torque increases abruptly at the rotation angle φ of 60° and then follows again the characteristic progression of a largely linear ascent.

However, many screwdriving operations are those that have less of a focus on tightening torque in the sense of a torque screw connection but are simpler and thus also more efficiently controlled by the angle of rotation. This means that the screwdriving process would be considered completed when the socket has travelled a certain angle of rotation; in this case of a screwdriving progression shown in FIG. 1B, the slipping of the socket could have gone unnoticed and the screw could not have been fully tightened to the required angle of rotation and/or could have been damaged.

This must also be avoided as far as possible, whereby it is problematic to have already detected a faulty screwdriving process, because even if screwdriving progression 2 shows a recognizable faulty screwdriving process, the production process is already delayed or necessarily stopped.

FIG. 2 shows in principle a view of a screwdriving tool 10 with respect to an object 20, into whose screw base 21 a previously mentioned screw 1 with screw head 3 is to be screwed.

In the current example, screwdriving tool 10 can advantageously be a stationary automatic screwdriving machine or a hand-held screwdriving tool.

Screwdriving tool 10 includes a screwdriving tool head 12 and a screwdriver drive 14. Screwdriver drive 14 is used to drive a spindle 11 of screwdriving tool head 12, wherein a screwdriving way 13 such as the aforementioned socket can be applied to spindle 11 on the head side. Socket 13 receives screw head 3 of screw 1 and screws it in by way of screwdriver drive 14, to which spindle 11 is coupled via an output 16.

In principle, a statement can be made at and/or before the start of the actual screwing process as to whether socket 13 is in a joint state with screw head 3 via a distance measurement A between socket 13 or similar screwdriving way and screw base 21, provided the basic height of a screw head 3 is known.

This already applies to a screwdriving tool in the embodiment of a hand-held screwdriving tool, for example, the screwdriving tool 10. In addition to the quality aspect, there is also a safety aspect for hand-held screwdriving tools such as hand-held screwdrivers with supports, as slipping may lead to uncontrolled movements that can result in injuries or damage.

Because hand-held screwdrivers usually do not have a spring-loaded spindle, but permanently mounted sockets, a suitable measurement is already possible if a constant distance to the component is always checked.

In the case of hand-held screwdrivers, the measurement could therefore be performed directly on the component with a laser probe or a similar contactless measuring device for the sake of simplicity. This also improves the accessibility of the measuring system at the screw point. In the case of a hand-held screwdriving tool, it is therefore already helpful to overcome the above problem if a distance dimension A1 to screw base 21 is known.

The screw (with screw head 3) can thereby be screwed in, in a conventional manner with the screwdriving tool. Before an increased torque is applied, verification of distance dimension A1 has shown itself to be beneficial.

Zeroing could therefore be done directly on the component, for example by way of a button on the screwdriver or sensor housing. Zeroing should always be performed after a socket change.

The accuracy of the measurement could be slightly limited compared to stationary systems and could possibly also be influenced by the reflection of the component surface. However, this would be acceptable or correctable in the case of hand-held screwdriving tools in an unsteady situation (i.e. screwdrivers are often naturally held slightly tilted). There are simple command and implementation options to remedy the situation. For example, zeroing could be performed by pressing the button longer and, if necessary by pressing it a second time. A measured average value could also be used. This could reduce measurement errors caused by “tilting” the screwdriving tool or similar issues.

With hand-held screwdriving tools, in particular with electronic torque wrenches, a warning would be possible, especially an acoustic warning when a torque is built up, when however, the verification of distance dimension A1 shows that the socket is not in a sufficiently joint state.

Detection of a corresponding relative dimension of a distance dimension A1 to screw base 21 and a distance dimension A2 to the upper edge of socket 13 could also be advantageous. This can make a further improved statement possible, from which it can be seen that socket 13 is in a joint state with crew head 3. Distance measurement A can also be performed, for example, via a laser measurement.

Basically, an absolute height of the screw spindles must also be checked or known before the actual screwing process begins. This can be done advantageously with a differentiation accuracy of +/−0.5 mm, which can be adjusted, for example, in a parameter window.

With this approach, which is advantageous in the concept for a screw-in process, joining of screw head 3 and screwdriving way such as socket 13 must be checked before the actual screwdriving process begins.

However, as explained and although correctable, it is problematic that distance measurement A1 is performed in relation to screw base 21 and especially socket 13. There are many possible sources of error in this situation. For distance measurement A1 prior to the screwing process, this can be improved, especially in view of the design of a stationary screwdriving tool or the screwdriving tool head.

The spindle height can, in principle also be measured directly on socket 13—as explained above—basically, if the resulting uncertainties (for example, due to wobbling in the square clearance, possibly requiring special sockets, etc.) would be sufficiently manageable. In order to be able to evaluate the joint state of the socket, the distance from the screwdriver to the engine housing must also be measured and calculated as an example of screw base 21 in addition to the measured spindle height in the alternative shown in FIG. 2. The value of the joint state of the socket is determined in the same way but is not identical to the immersion depth in other variants for which a “socket joint check” is also to be performed.

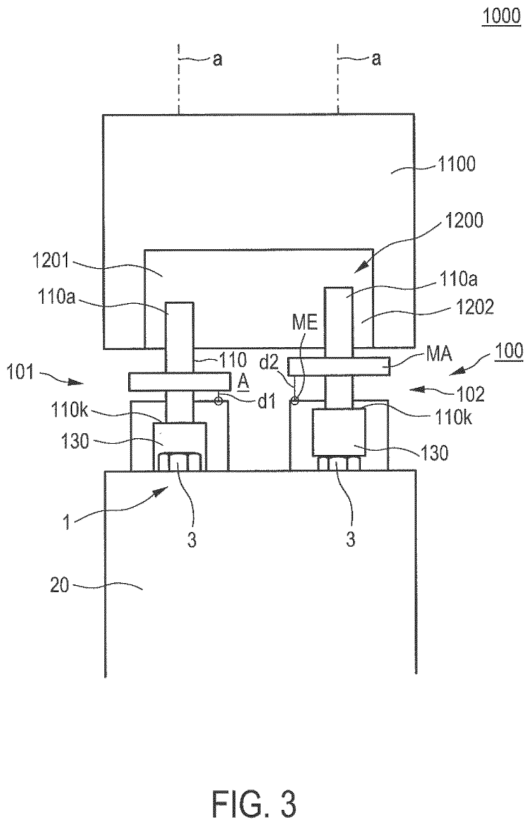

In contrast, FIG. 3 shows an improved optional embodiment of a screwdriving tool head 100 which is installed in a screwdriving tool 1000, in particular, in a stationary screwdriving tool, although (where applicable) application in a hand-held screwdriving tool is also basically possible.

It is therefore more reliable to measure on a precise, tilt- and shift-proof measuring plate or similar device for a measuring attachment designed for distance measurement. As shown below, this should be arranged especially advantageously directly above the output square of the spindle. In principle, a measuring attachment that is designed for distance measurement can be attached to the spindle between the drive side and the head side.

Screwdriving tool 1000 is shown here in the embodiment of an automated screwdriving machine, which is optionally used for automatic screwing of a large number of screws on a complex object such as an engine of an internal combustion engine.

The automated screwdriving machine shown here has a screwdriver drive 1100, which drives at least one spindle of the screwdriving tool head via an output 1200. The screwdriving tool head, which is designed in this case as a double screwdriving tool head 100, has a first and a second spindle unit 101, 102, wherein a first output unit 1201 is designed to drive a first spindle of first spindle unit 101, and a second output unit 1202 is designed to drive a second spindle of second spindle unit 102.

In principle, screwdriving tool head 100 can also be designed as a single screwdriving tool head—similar to that shown in FIG. 2—in other words, with only a single spindle unit.

As shown by an embodiment of a double screwdriving tool head illustrated here as a non-restrictive example, it has proven advantageous for screwdriver drive 1100 to be designed using the output shown here in the diagram. This means that in the current example a first and second output 1201, 1202 and a first and second spindle 110, 120 of first and second spindle units 101, 102 are provided; the drive can and should be synchronized with each other. This leads to a more even load on the structure and thus also to greater dimensional accuracy during the screwing process. Screwdriving tool 1000 shown here as an automated screwdriving machine with a double screwdriving tool head 100 can, however, also be designed separately and individually, for example with a single screwdriving tool head, such as for example in the case of spindle unit 101 or spindle unit 102. In another variant not shown here, the screwdriving tool can also be designed as a multi-spindle machine with more than two tool heads, for example, as a three- or four-spindle machine.

For the sake of simplicity and clarity, the same reference numerals are used below for identical or similar components or for components performing identical or similar functions of a first and/or second spindle unit 101, 102.

Spindle unit 101, 102 of screwdriving tool head 100 is used to screw a screw 1 recognizable by screw head 3 into an object 20, such as an internal combustion engine. Such automated screwdriving machines shown in FIG. 3 are used as the optional design of a screwdriving tool 1000 when screwing screws into a connecting rod or cylinder head, cylinder cover or housing of an engine. Such screws are safety-relevant and the screwdriving tool is thus subject to a special assurance of a safe screwdriving process for screwing in screw 1 with screwdriving tool 1000.

As explained with reference to FIG. 1 to FIG. 2, such processes are performed as a torque screw connection, but above all as a rotation angle-controlled process of a screw connection. The automated screwdriving machine can optionally be designed as a semi-automatic machine or even as a fully automatic machine. It includes a unit, not shown here in detail, for sensory detection of the screwdriving process itself and, if necessary, the display of one or more monitoring parameters for the screwdriving process, such as the screwdriving progression as shown in FIG. 1B as an example.

Accordingly, screwdriving tool head 1000 has a spindle unit 101, 102, which respectively has a spindle 110, 120 arranged axially—that is, on an axis a of spindle unit 101, 102—with a drive side 110a and a head side 110k. On the drive side, spindle 110 can be coupled to drive unit 1200 of automated screwdriving machine 1000 and is designed to rotate above it, and on spindle 110 a previously explained screwdriving way 130, for example the socket explained above, is attached to the head side. Screwdriving way 130 is used to be applied to a screw head 3 of screw 1 and is thus brought into a joint state with screw head 3 for gripping and screwing in the screw.

On the left side of the embodiment shown in FIG. 3 relating to spindle unit 101, screwdriving way 130 is in a joint state with screw head 3. On the right side of spindle unit 102, screwdriving way 130 is applied to screw head 3, but is not in a joint state. This is a situation that exists either before the screwing-in process or is highly undesirable during a screwing-in process.

If screwdriving way 130 is applied to screw head 3 but is not in a joint state with it, it can lead to the aforementioned problems at the beginning of the screwdriving process, in other words, to damage to screw head 3 and the further screwdriving process with all the associated production interruptions and safety concerns.

For this reason, a distance measurement A is provided in the present example, in particular a distance measurement A that is improved in comparison to the aforementioned distance measurement A1, and which is described below for a spindle unit 101, 102. On the one hand, the concept of the invention is based on making available a distance measurement A1 as explained with FIG. 2, by way of which, when carried out on screwdriving tool head 12, the optionally automated screwdriving machine is able to determine by way of an automated test step before the actual screwing process whether screwdriving way 130 is in a joint state with screw head 3.

The concept of the invention thereby considers—as explained and evident from the diagram in FIG. 3—that a distance measurement A is as independent as possible of the type of screwdriving way currently used. This means that it is irrelevant which socket 130 is used in the present example.

The optional embodiment of a screwdriving tool head 100 on screwdriving tool 1000 provided for in FIG. 3 according to the concept of the invention therefore initially provides for a spindle 110, 120 arranged on spindle unit 101, 102—as already explained axially arranged along an axis a of the spindle unit—with a drive side 110a and a head side 110k. Spindle 110 shown in FIG. 3 is therein coupled to drive unit 1200 of the screwdriving tool on the drive side and can be turned or rotated by way of it.

By way of the rotational design or multiple rotation of spindle 110 and screwdriving way 130—in this example in the embodiment of the socket—available on the head side of spindle 110, the latter, when being applied to screw head 3 of screw 1, is thus in a position to turn screw 1 and then screw it into the screw hole in the basic screw support of object 20.

Spindle unit 101, 102 has a previously discussed independent distance measurement A with a recognized advantage, that is, a distance measurement A that is independent of the type of screwdriving way 130 currently used and a suitable arrangement of measuring attachment and measuring device interacting with the measuring attachment for carrying out distance measurement A.

A measuring attachment MA which is designed for a distance measurement A is attached to spindle 110, 111, 112, between drive side 110a and head side 110k, and a measuring device ME designed for distance measurement A and interacting with the measuring attachment is attached to the reference structure-in the current example a sleeve 121, 122 surrounding the spindle-between head side 100k of the spindle and measuring attachment MA.

In the present example, measuring attachment MA is firmly connected with spindle 110 and thus indicates a height position of spindle 110; in principle, a measuring attachment MA can also be connected or coupled to spindle 110, 111, 112 in a different manner.

In the present example, measuring device ME is firmly connected with the sleeve and thus indicates a height position of sleeve 121, 122; in principle, a measuring device ME can also be connected or coupled to the sleeve in another way.

In principle, the arrangement shown in the embodiment of FIG. 3 could also be reversed in that the measuring attachment is arranged on the sleeve, and the measuring device is arranged on the spindle, and this is in this respect “firmly” connected to indicate a height position.

This means that in one variation—not shown here—it may be provided that a measuring device ME is attached to spindle 110, 111, 112 between drive side 110a and head side 110k for a distance measurement A, and on the reference structure a measuring attachment MA is attached between head side 110k of the spindle and measuring device ME which is designed for distance measurement A and to interact with measuring device ME.

In any event, a distance measurement A occurs in that measuring device ME (in this example arranged on the sleeve and firmly connected to it for height indication) interacts with measuring attachment MA (in this example arranged on the spindle and firmly connected to it to indicate a height position). This means that measuring device ME has physical way(s) able to specify a distance in the sense of a distance d between measuring device ME (and in this respect relevant for the sleeve) and measuring attachment MA (in this respect relevant for the spindle).

In another variation, which is also not shown here, a distance can also be understood as a distance between the measuring device and the measuring attachment, set in relation to one another. In principle, an approach would also be conceivable in which measurements are taken directly from spindle 110, 111, 112 as well as from sleeve 121, 122, with a sensor respectively pointing directly downwards, for example, onto the component to be screwed. Two sensors would then be required, in other words, two measuring devices ME.

In a direct measurement, one could also measure directly with a sensor onto the component, but no deflection of the spindle must occur when it is placed on the component; thus this approach has certain limitations. The spindle would have to protrude rigidly from the screwdriving device. In the variation shown here, the sleeve offers the advantage that the deflection is detected when the difference between “sleeve component” and “spindle component” is calculated.

In the present example it can be seen on the left side of spindle unit 101 that a distance d1 between measuring device and measuring attachment ME, MA is less than a distance d2 on the right side of FIG. 3, that is, on spindle unit 102. The reason is that the sleeve (first and second sleeve 121, 121 is not shown for clarity reasons) on both spindle units 101, 102 rests on the base screw support, that is on screw base 21. On first spindle unit 101, the situation of the spindle relative to spindle 110 of second spindle unit 102—that is, specifically with screwdriving way 130—is different. This means, a distance d1 between measuring device and measuring attachment ME, MA is less on the left than distance d2 between measuring device and measuring attachment ME, MA on the right, since first spindle 111 of left spindle unit 101 sits (can sit) “lower” than second spindle 112 of right spindle unit 102 (since second spindle 112 “hangs” further up on screwdriving way 130).

It can be said that on the left-hand side of spindle unit 101, screwdriving way 130 in the embodiment of the socket is in a joint state with screw head 3, namely completely covers and encompasses it. In other words, a complete, force-transmitting positive fit that can withstand an optimized or optimum to maximum torque is achieved between screwdriving way 130 and screw head 3 in this fully joint state on the left side of spindle unit 101. In contrast, screwdriving way 130 in the embodiment of the socket is applied on the right-hand side of spindle unit 102 to screw head 3; however, screwdriving way 130 in the embodiment of the socket only clearly encompasses screw head 3 on the right-hand side of spindle unit 102 at best only at its upper edge or not at all.

In a subsequently beginning turning process, that is, spindle 110 and screwdriving way 130 in the embodiment of the socket rotating, the following would occur:
on left spindle unit 101, a screwing-in process of screw 1 with screwdriving way 130 is fully implemented and completed by right spindle 110—here the first spindle—because the torque applied can be fully transmitted from the socket to screw head 3 throughout the entire screwing-in process, and screwdriving way 130 in the embodiment of the socket can then again be removed from screw head 3. Screw head 3 will remain completely intact and undamaged. The screwing process can be implemented securely with rotational angle control because the number of intended turns of screw 1 can be carried out safely and reliably as a result of screwdriving way 130 being in a fully joint state with screw head 3.

This is certainly not the case with spindle unit 102 shown on the right. The greater distance d2 between the measuring device and measuring attachment ME, MA on the right—because first spindle 111 of left spindle unit 101 sits (can sit) “deeper” than second spindle 112 of right spindle unit 102 (because second spindle 112 “hangs further up on screwdriving way 130”)—indicates this.

When the socket begins to turn by way of right spindle 110—in this case, second spindle 112—it would slip off screw head 3 at the start, since it does not attach to screw head 3, or is applied only in a small area. In any case, however, a screwing process would have to be interrupted with increasing torque if the socket were to slip off the screw head as a result of the increasing torque.

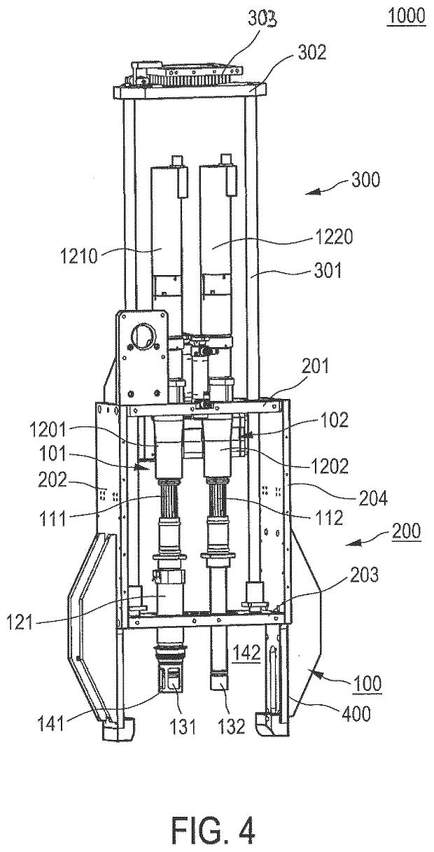

FIG. 4 shows in detail the structural design of a screwdriving tool 1000 in the embodiment of an automated screwdriving machine, in the current example specifically a semi-automatic screwdriving machine. For the sake of simplicity, the same reference signs numerals are also used in this case for the same or similar components or components fulfilling the same or similar function in FIGS. 4 to 7. Not shown here is object 20 such as, for example, an engine of an internal combustion engine, as is sufficiently recognizable symbolically in FIG. 3 and FIG. 2 and also applies in principle to FIG. 4 to FIG. 6.

In the present example, screwdriving tool 1000 has a screwdriving tool head designed as a double screwdriving tool head 100, which is accommodated in a housing frame 200, wherein housing frame 200 is in turn held in a support structure 300 of screwdriving tool 1000. Housing frame 200 of the screwdriving tool head could be supported by a load-bearing and stable supporting device 400 (in reality, however, this is only necessary as an emergency protection with a two-spindle or multi-spindle device if one of the two sockets breaks, because otherwise the screwdriving tool would rotate on its own axis and thus become a hazard. Otherwise, the other spindle serves as a counter-holder or momentary support).

Housing frame 200 of the screwdriving tool head can be placed with this supporting device 400, for example, on a cylinder cover surface or engine surface or a similar screwing base 21 for screwing a screw 1 into a corresponding object 20 such as an engine, as explained with reference to FIG. 2 and FIG. 3.

In the current example, support structure 300 is designed as a rod assembly 301, which is covered on the upper side by a rod assembly plate 302. Rod assembly plate 302 supports additional devices in support of the function of screwdriving tool 1000, for example, a rotating element 303 shown here, which is connected with the surroundings of the housing of screwdriving tool 1000 (not shown here) in a tolerance-compensating manner.

Support structure 300, with its rod assembly 301, penetrates an upper wall 201 of the particularly stable housing frame 200, which has a lower wall 203 opposite upper wall 201 and side walls 202, 204. Housing frame 200 can thus be understood as a box-like frame structure consisting of solid plates for creating walls 201, 202, 203, 204. Support structure 300 is supported on lower wall 203 by rods 301 that penetrate upper wall 201.

Located inside housing frame 200 is screwdriving tool head 100, in this example, the double screwdriving tool head, with a first spindle unit 101 and a second spindle unit 102. For the aforementioned reason, spindle units 101, 102 are designed to be driven by way of drive units 1210, 1220—which are arranged above upper housing wall 201—via a corresponding first and second output drive 1201, 1202 below upper supporting wall 201; in this example, these are driven in synchronization with one another.

As can be seen in the lower part of FIG. 4, spindle unit 101 is shown with a sleeve to be described in more detail, and second spindle unit 102 is shown without said sleeve in order to provide a clearer view of the second spindle.

This said, each spindle unit 101, 102 has a spindle 111, 112 arranged axially relative to spindle unit 101, 102, on each of which a screwdriving way 131, 132 in the embodiment of a socket is accommodated on the head side. Each of spindles 111, 112 is thus individually coupled on the drive side to one of the drive units 1210, 1220 and is rotatable via associated output drive unit 1201, 1202. This allows a screw to be screwed into a corresponding object using screwdriving way 131, 132, that is, via the screw head that is in a joint state with the screwdriving way.

A first and second sleeve 121, 122 surrounding first and second spindles 111, 112 extends outside axis a and centered around axis a of spindle unit 101, 102; in other words, first and second sleeve 121, 122 are arranged circumferentially around axis a and first and second spindle 111, 112, respectively. First and second sleeve 121, 122 are each held in the respective spindle unit 101, 102 so as to be axially movable relative to spindle 111, 112, which is arranged to be rotatable on its axis. First and second spindle 111, 112 are each freely rotatable relative to first and second sleeve 121, 122. In other words, first sleeve 121 surrounds rotatable first spindle 111 without contact, and second sleeve 122 surrounds rotatable second spindle 112 without contact. At the end of a sleeve, a first and second cage 141, 142 (the latter not shown) is designed as an integral part of the same or on or with the same, molded onto or attached thereto or otherwise with a stop to first and second sleeves 121, 122 and held by the first and second sleeves respectively.

In general, a spacer element can be provided for the reference structure, wherein the spacer element is designed to be placed on a screw base. In particular, the spacer element is provided and/or designed as an element that maintains a distance between the screw base and the reference structure, and/or the spacer element is held on and/or with a stop to the reference structure and by the reference structure. The spacer element can have one or a number of the elements selected from the group of elements arranged individually or in pairs, consisting of: a plate, a finger, a pin, a tube, a cage, in particular wherein the tube and/or the cage are designed to surround the head side and the screwdriving way.

Instead of designing the spacer element as a cage 141, 142, in a variation not shown here the spacer element could also be designed as a half cage or finger or plate.

A socket is arranged respectively in cage 141, 142 shown here or surrounded by it, in other words, in the present example first and second screwdriving way 131, 132 are held on first and second spindles 111, 112, respectively.

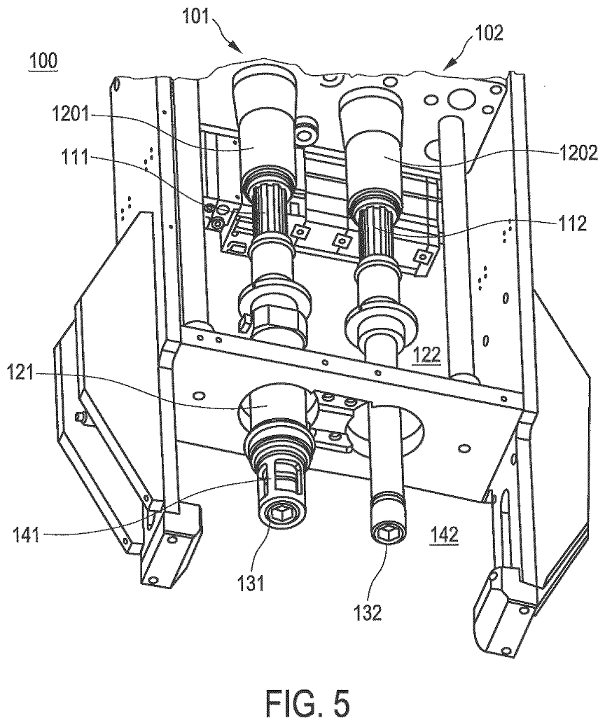

FIG. 5, shows precisely this arrangement of spindle units 101, 102 of screwdriving tool head 100 arranged side by side, each with aforementioned first and second output drive units 1201, 1202, first and second spindles 111, 112, first and second sleeves 121, 122, first and second cages 141, 142, respectively surrounding a first and second screwdriving way 131, 132.

The measuring attachment can be designed as a measuring plate around the spindle, as shown here. The measuring attachment and the measuring device are recognizably arranged along a distance measuring section extending axially along the spindle unit, wherein the measuring section extends along the spindle between an upper end of the sleeve and the drive side.

It is not shown in the present example, that the screwdriving tool head can be expanded by a calibration ring.

The calibration ring is held advantageously but not necessarily with a stop to the sleeve and by the sleeve. The calibration ring is advantageously designed surrounding the head side and the screwdriving way, wherein the calibration ring is further designed, for being placed onto a screw base, wherein the calibration distance set by the calibration ring for moving the sleeve axially and relative to the spindle is known and determinable.

The calibration ring is designed, for example, like a washer or, more generally, like a plate with a hole. In the simplest case, the washer-like calibration washer or, more generally, calibration plate can simply be placed over/around the screw head so that the head protrudes through the hole. The spacer element, in particular the cage, then measures the higher surface of the washer-like calibration disk or, more generally, calibration plate instead of the component surface beneath it, in other words, the screw base.

The spindle and/or sleeve may be spring-mounted, in particular spring-loaded.

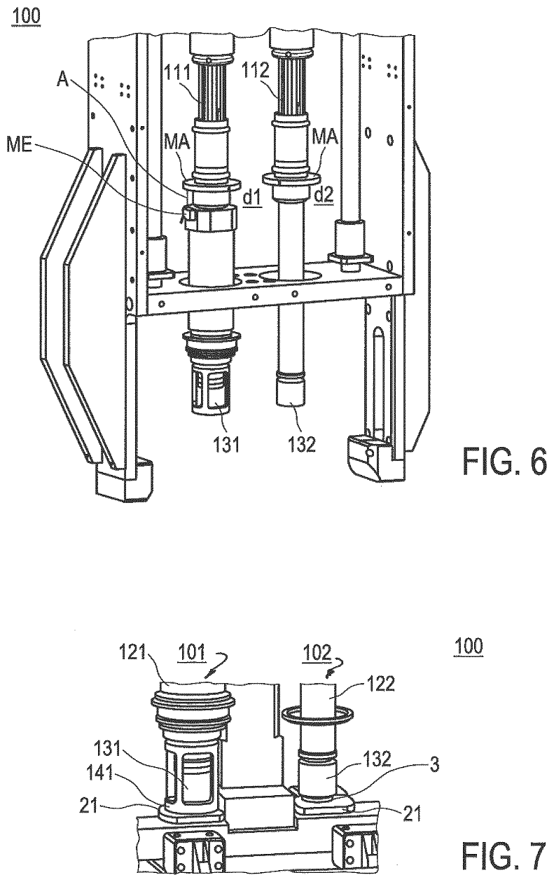

In FIG. 6, the same embodiment of screwdriving tool head 100 is shown in a lateral perspective view, wherein reference is made below to spindle 111, 112, which is equipped with a measuring attachment MA for distance measurement A, and to the sleeve, which is equipped with a measuring device ME for distance measurement A; which are therefore designed to interact for distance measurement A.

Distance measurement A records a distance d1, d2 between the upper edge of first or second sleeve 121, 122 and measuring attachment MA respectively, wherein this difference can be interpreted as an indication of whether aforementioned first or second cage 141, 142 is not only placed on a screw base 21, but rather, moreover, when the cage is placed, the first or second screwdriving way 131, 132 accommodated on the head side of spindle 111, 112 is in a joint state with screw head 3 of a screw1 that is to be screwed in.

Shown on the left side in FIG. 7 is the screwdriving way that is accommodated at the head side being applied to the screw head and being in a joint state with it. First cage 141 rests on screw base 21, and the first screwdriving way in the embodiment of socket 131 fully engages screw head 3 over its entire circumference and height. Screw head 3 is thus not visible.

This means that first sleeve 121, with its visible continuation towards the head side of first cage 141 shown on the sleeve or with a stop against the sleeve and held by the sleeve has thus its lowest position; it or the first cage 141 reaches namely the screw base 21 and rests there; the lower edge of first cage 141 should therefore rest flush with the lower edge of screwdriving way 131 on screw base 21.

If collar screws are used, the lower edge of the screwdriving way does not rest on screw base 21 but is slightly raised on the collar of the collar screw. This changes the target position of the lower edge of the screwdriving way from “screw base 21” to “screw base 21 plus collar height of the screw”.

Since it is a measuring system, it can also be used for this purpose. In this case, only a different off-set value is to be used.

On the right-hand side of the screwdriving tool with screwdriving tool head 100 shown in FIG. 7, this is, however, clearly not the case. The socket, as the second screwdriving way 132, is applied to screw head 3 and encompasses it completely, but is however not in a fully joint state with it. This is recognizable because the socket as screwdriving way 132 does not rest on screwdriving base 21.

Thus, while a second sleeve 122 with a second cage 142 on the head side would stand up on screw base 21, second spindle 122—in contrast to first spindle 121—would stand up at a distance due to the socket as the second screwdriving way 132 only being applied to but not being in a joint state.

This difference can be recognized by measuring attachment MA arranged on the spindle between the drive side and the head side for distance measurement A, as shown in FIG. 6.

In the case of right spindle unit 102—the corresponding representation is schematically given in FIG. 3—a distance dimension would be greater than distance d2, since “right” measuring attachment MA is raised compared to “left” measuring attachment MA of FIG. 7 or FIG. 3, so that distance d1 is less than distance d2 with distance measurement A.

It can therefore be seen that the design of the first sleeve and cage 121, 141 or the second sleeve and cage 121, 142 is selected such that regularly mounted cage 141, 142 is designed with a stop to the sleeve and held by the sleeve for moving the sleeve axially and relative to spindle 111, 112. A relative displacement path between sleeve 121, 122 on the one hand and spindle 111, 112 on the other hand is thus detected by measuring device ME interacting with measuring attachment MA. Accordingly, distance measurement A is designed to indicate a corresponding first and second distance dimension d1, d2, in particular by way of the relative displacement path between sleeve 141, 142 and spindle 111, 112.

The respective distance dimension can then be set relative to a distance dimension threshold value, which can be used to indicate whether screwdriving way 131, 132 is in contact with the screw head 3. In this case, the determination can be made that second distance dimension d2 is too large in the sense that it is greater than a predetermined distance dimension threshold value (for example specified by d1). As a result, it can then be determined that the screwdriver socket is not sufficiently joint with screw head 3 in spindle unit 102 and that a screwing process should therefore not be started.

The measuring device can be designed as either a contact-type device (i.e., as a mechanical measuring probe) or a non-contact measuring device. This can be used, in particular, to detect a measuring pulse time or a phase-sensitive measuring signal between the measuring attachment and the measuring device, optionally a measuring device based on a light signal, a radio signal, or a similar electromagnetic measuring signal, or an acoustic measuring signal between the measuring attachment and the measuring device.

The measuring device can be designed to transmit and/or receive an evaluation and/or information signal. In particular, the evaluation and/or information signal can contain one or more items of specification or evaluation information selected from the group of specification or evaluation information consisting of: an offset value for a screw head of a screw, in particular a screw head with a collar; a tolerance value for a screw head of a screw; a protrusion value for a protrusion of a screw head from the screw base; a calibration distance for moving the sleeve axially and relative to the spindle; and a distance dimension threshold value indicating that the screwdriving way is applied to the screw head.

A measurement evaluation unit can be designed to detect one or a number of the evaluation variables that are selected from the group of evaluation variables consisting of: number of confirmed and/or non-confirmed threading processes in which the screwdriving way accommodated on the head side of the spindle is applied to the screw head, in particular is in a joint state with the screw head; one or more threshold values for the number of threading processes and/or for a time period of a threading process.

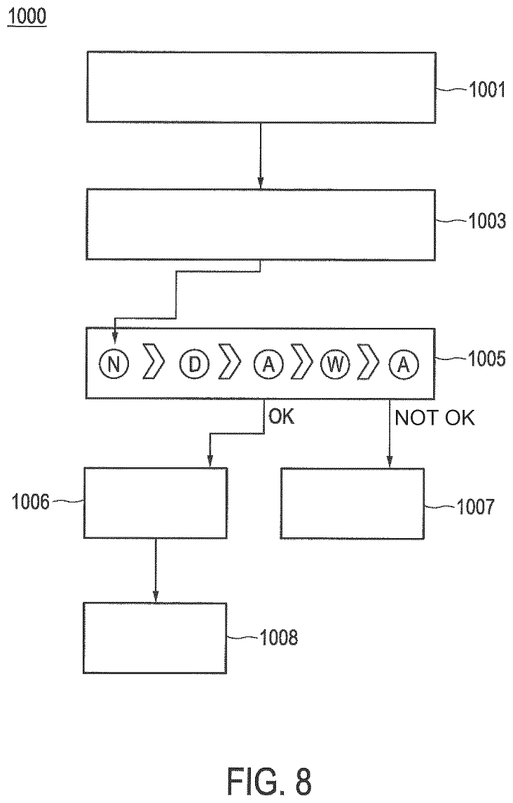

The method for screwing in the screw with a screwdriving tool 1000 that is to be carried out according to the concept of the invention within the framework of a particular embodiment thus includes the following steps with reference to FIG. 8:
optionally, in a first step 1001, screw 1 is screwed in until a protrusion dimension is reached;
in a second step 1003, the screw is threaded. In other words, screwdriving way 130 is applied to screw head 3, that is, screw 1 is threaded in such a way that, with the cage in place, screwdriving way 130, which is accommodated on the head side of the spindle, is applied to screw head 3 in such a way that it is in a joint state with the screw head; this is not yet guaranteed at this point by the automatic mechanism of the automated screwdriving machine. However, the automatic mechanism of the automated screwdriving machine according to the concept of the invention is designed such that screwdriving way 130, which is accommodated on the head side of the spindle, is applied to screw head 3 in such a way that it is in a sufficient, in particular fully, joint state with the screw head;
according to the concept of the invention, in a further step 1005, a check is performed to determine whether screwdriving way 130 is in a joint state with screw head 3. This is done by way of the measuring device attached to the sleeve, which is designed for distance measurement and interacts with the measuring attachment arranged on the spindle, as will be explained with reference to step 1005; that is, the present embodiment of the invention optionally only applies after the screw has been screwed in. The screw is screwed in using a conventional cordless screwdriver, and then the concept of the invention comes into play;
in a further step 1006, screw 1 is screwed in using screwdriving tool 100. However, according to the concept of the invention, screw 1 is screwed in in step 1006 only if distance measurement A confirms that screwdriving way 130, mounted on the head side of the spindle, is in a joint state with screw head 3. In other words, the screwing process involving screwing in the screw in step 1006 only takes place if the distance measurement is “OK.”

The screwing process is properly completed in a further step 1008 so that the next screwing process can follow.

If the measurements of spindle height and screwdriver distance show that a socket has not been fully threaded on, the “threading-on process” must be repeated automatically (the number of repetitions that the screwing device automatically performs when another “not OK” evaluation is made).

If, on the other hand, a distance measurement is “not OK” even after a repetition W, an error message occurs in step 1007. In this case, the process should be intervened in order to correct the semi-automatic machine or similar screwdriving tool 1000.

Step 1005 for checking whether the screwdriving way is in a joint state with the screw head includes the following steps before the distance measurement A or, if necessary, repeated W distance measurement A: zeroing N and documenting D.

In one variation, zeroing N is advantageously performed prior to the assembly process during startup of the system. This has the advantage that during the actual screwing process, only distance d that is set after the screwing device is placed needs to be measured and compared with the corresponding limit values.

A computer program product can be designed to carry out the method for screwing in a screw with a screwdriving tool when the computer program product is implemented on a screwdriving tool.

The device and the method for the “socket-joint check”, as shown here in an optional embodiment, can be quickly and easily checked and, if necessary, zeroed on measuring stands.

In particular, the computer program product can be created for this purpose. In particular, this can include a human-machine interface, such as a query menu, for example in a view or, if appropriate, implemented in another suitable way, for example as a program. Suitable master parts can be created.

For insertion, the respective spindles can be lifted by springs and the master parts can be pushed underneath. A procedure can include a calibration process as follows:
Zero measurement on the measuring stand→checking (zeroing if necessary) the zero value;
Small spacer for measuring minimum permissible height→simulation of sockets that are almost completely but not yet in a fully joint state;
Large spacer for measuring maximum permissible height→simulation of sockets in only a minimally/barely joint state;
Oversized spacer for measuring excessive, no longer permissible height→simulation of sockets that is only in a minimally or barely joint state.

A spacer in the embodiment of a calibration ring has proven advantageous. The calibration ring is shaped, for example, like a washer or, more generally, like a plate with a hole. In the simplest case, the washer-like calibration disk or, more generally, calibration plate can simply be placed over/around the screw head so that the head protrudes through the hole. The spacer element, in particular the cage, then measures the higher surface of the washer-like calibration disk or, more generally, calibration plate, instead of the component surface/screw base beneath it.

It is not actually necessary for it to be “held by the sleeve.” It is sufficient if the washer-like calibration disks can simply be placed over/around the screw head so that the head protrudes through the hole. The cage/distance/finger then measures on the higher surface of the calibration plate instead of on the component surface/screw base beneath it.

Another option could be chosen, wherein the cage or a finger or a similar spacer element would be extended downwards by way of a calibration plate (for example, a magnetic washer) or another mechanical extension. This is more complex but achieves the same effect. This could also be achieved (for example, in cases of poor accessibility) by way of a cage/finger extended by the thickness of the washer, which is specifically designed and used for calibration purposes.

If zeroing occurs, this must be documented under the event or fault messages with a time stamp and saved in a retrievable manner.

If the measurements of spindle height and screwdriver distance show that a screw has not been fully threaded, the “threading process” must be repeated automatically, at least for a number of repetitions which the screwdriver automatically performs in the event of a new “out of order” assessment.

### COMPONENT IDENTIFICATION LISTING

1 screw
2 screw progression
3 screw head
3a, 3b, 3c damages
5 thread
10, 1000 screwdriving tool
11 spindle
12, 100 screwdriving tool head
13 socket
14, 1100 screwdriver drive
16, 1200 output
20 object
21 screw base
101 first spindle unit
102 second spindle unit
110 spindle
110a drive side
110k head side
111 first spindle
112 second spindle
120 second spindle
121, 122 sleeve
130 screwdriving way
131, 132 screwdriving way/socket
141, 142 cage
200 housing frame
201 upper wall
202, 204 side walls
203 lower wall
300 structure
301 rod assembly
302 rod assembly plate
303 rotating element
400 supporting device
1001 step
1003 step
1005 step
1006 step
1008 step
1200 drive
1201 first output unit
1202 second output unit
1210 first drive unit
1220 second drive unit
A distance measurement
A1, A2 distance dimension
D documenting
d, d1, d2 distance
M torque
MA measuring attachment
ME measuring device
N zeroing
W repetition
F angle

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A screwdriving tool head, comprising:
at least one spindle unit which is configured for accommodating a screwdriving device to screw in a screw or a screw element similar thereto, the screwdriving tool head being configured for being installed in a screwdriving tool, the at least one spindle unit including:
a spindle arranged axially with respect to the spindle unit, the spindle including a drive side and a head side, wherein the spindle is configured for being coupled on the drive side to an output unit of the screwdriving tool and is configured for being rotated positionally relative to the output unit, the screwdriving tool head being configured such that the screwdriving device is configured for being accommodated on the head side of the spindle for application to a screw head of the screw;
a reference structure, which extends at least partially along at least a portion of the spindle unit, is movable axially relative to the spindle, and is held on at least a part of the spindle unit, and is configured for being rotated relative to the spindle;
a measuring attachment;
a measuring device, wherein one of:
(a) the measuring attachment is configured for a distance measurement and is attached to the spindle between the drive side and the head side; and
the measuring device is configured for the distance measurement and interacting with the measuring attachment and is mounted to the reference structure between the head side of the spindle and the measuring attachment; and
(b) the measuring device is configured for the distance measurement and is mounted on the spindle between the drive side and the head side; and
the measuring attachment is configured for the distance measurement and interacting with the measuring device, and is mounted to the reference structure between the head side of the spindle and the measuring device; and
a spacer element, which is in addition to the reference structure or is formed with the reference structure, the spacer element being configured for being placed on a screw base.

2. The screwdriving tool head according to claim 1, wherein the at least one spindle unit is configured such that when the spacer element is attached the screwdriving device accommodated on the head side of the spindle is configured for being applied to the screw head such that the screwdriving device is in a joint state with the screw head, wherein by way of the distance measurement the screwdriving device is configured for being recognized as being in the joint state with the screw head.

3. The screwdriving tool head according to claim 1, wherein the spacer element is provided or is configured for being between the screw base and the reference structure.

4. The screwdriving tool head according claim 1, wherein the spacer element includes at least one element or a plurality of elements arranged in a pair which is selected from the following group: a plate; a finger; a pin; a tube; and a cage.

5. The screwdriving tool head according to claim 1, wherein the reference structure is formed as a sleeve which extends off-axis of the at least one spindle unit and surrounds the spindle.

6. The screwdriving tool head according to claim 1, wherein the screwdriving tool head further includes a stop, wherein the spacer element is placed on the screw base with the stop to the reference structure and is configured for moving the reference structure axially and relative to the spindle, wherein the screwdriving tool head is configured such that a relative displacement path between the reference structure and the spindle is detected by the measuring device interacting with the measuring attachment.

7. The screwdriving tool head according to claim 1, wherein the distance measurement specifies a distance dimension, wherein the distance dimension relative to a distance threshold value indicates that screwdriving device is in a joint state with the screw head.

8. The screwdriving tool head according to claim 1, wherein at least one of (i) the measuring attachment is configured as a measuring disk around the spindle, and (ii) the measuring device is a non-contact measuring device.

9. The screwdriving tool head according to claim 1, wherein the measuring attachment and the measuring device are arranged along a distance measuring section extending axially along the at least one spindle unit.

10. The screwdriving tool head according to claim 1, wherein the screwdriving tool head further includes a calibration ring and a stop, wherein the calibration ring is held with the stop to the reference structure, the calibration ring being configured to surround the head side and the screwdriving device, wherein the calibration ring is further configured to be placed on a screw base, wherein the screwdriving tool head is configured such that a calibration distance set by the calibration ring for moving the reference structure axially and relative to the spindle is determinable.

11. The screwdriving tool head according to claim 1, wherein at least one of the spindle and the reference structure is spring-mounted.

12. The screwdriving tool head according to claim 1, wherein the measuring device is configured at least one of to transmit and to receive at least one of an evaluation signal and an information signal, wherein at least one of the evaluation signal and the information signal contains a specification information or an evaluation information selected from a group of the specification information or the evaluation information consisting of: an offset value for the screw head of the screw; a protrusion value for a protrusion of the screw head relative to the screw base; a calibration distance for moving the reference structure-which is a sleeve-axially and relative to the spindle; and a distance threshold value indicating that the screwdriving device attaches to the screw head.

13. The screwdriving tool head according to claim 1, wherein the screwdriving tool head is configured such that a measurement evaluation unit is configured to detect at least one evaluation variable, which is selected from the group consisting of: at least one of a plurality of confirmed thread-on processes and a plurality of non-confirmed thread-on processes in which the screwdriving device that is accommodated on the head side of the spindle applies to the screw head; and at least one threshold value for at least one of (i) at least one of the plurality of confirmed thread-on processes and the plurality of non-confirmed thread-on processes and (ii) a time span of a respective thread-on process of at least one of the plurality of confirmed thread-on processes and the plurality of non-confirmed thread-on processes.

14. The screwdriving tool head according to claim 1, wherein the screwdriving tool head is formed as a double screwdriving tool head, wherein the at least one spindle unit is formed as a first spindle unit, wherein the screwdriving tool head includes a second spindle unit that is formed analogously to the first spindle unit.

15. A screwdriving tool, comprising:
a screwdriving tool head, which includes:
at least one spindle unit which is configured for accommodating a screwdriving device to screw in a screw or a screw element similar thereto, the screwdriving tool head being configured for being installed in a screwdriving tool, the at least one spindle unit including:
a spindle arranged axially with respect to the spindle unit, the spindle including a drive side and a head side, wherein the spindle is configured for being coupled on the drive side to an output unit of the screwdriving tool and is configured for being rotated positionally relative to the output unit, the screwdriving tool head being configured such that the screwdriving device is configured for being accommodated on the head side of the spindle for application to a screw head of the screw;
a reference structure, which extends at least partially along at least a portion of the spindle unit, is movable axially relative to the spindle, and is held on at least a part of the spindle unit, and is configured for being rotated relative to the spindle;
a measuring attachment;
a measuring device, wherein one of:
(a) the measuring attachment is configured for a distance measurement and is attached to the spindle between the drive side and the head side; and
the measuring device is configured for the distance measurement and interacting with the measuring attachment and is mounted to the reference structure between the head side of the spindle and the measuring attachment; and
(b) the measuring device is configured for the distance measurement and is mounted on the spindle between the drive side and the head side; and
the measuring attachment is configured for the distance measurement and interacting with the measuring device, and is mounted to the reference structure between the head side of the spindle and the measuring device; and
a spacer element, which is in addition to the reference structure or is formed with the reference structure, the spacer element being configured for being placed on a screw base; and
a screwdriver drive configured for driving at least one of the spindle of the screwdriving tool head.

16. The screwdriving tool according to claim 15, wherein the screwdriving tool head is formed as a double screwdriving tool head including a first spindle unit and a second spindle unit, the at least one spindle unit being the first spindle unit, the second spindle unit being formed analogously to the first spindle unit, the spindle of the at least one spindle being a first spindle of the first spindle unit, the second spindle unit including a second spindle, wherein the screwdriver drive includes an output with a first output unit and a second output unit, the first output unit being configured to drive the first spindle, the second output unit being configured to drive the second spindle.

17. The screwdriving tool according to claim 16, wherein the screwdriver drive is configured to implement a drive of the first spindle and the second spindle synchronized with each other by way of the output.

18. A method for screwing in a screw with a screwdriving tool, the method comprising the steps of:
providing that the screwdriving tool includes:
a screwdriving tool head, which includes:
at least one spindle unit which is configured for accommodating a screwdriving device to screw in the screw or a screw element similar thereto, the screwdriving tool head being configured for being installed in a screwdriving tool, the at least one spindle unit including:
a spindle arranged axially with respect to the spindle unit, the spindle including a drive side and a head side, wherein the spindle is configured for being coupled on the drive side to an output unit of the screwdriving tool and is configured for being rotated positionally relative to the output unit, the screwdriving tool head being configured such that the screwdriving device is configured for being accommodated on the head side of the spindle for application to a screw head of the screw;
a reference structure, which extends at least partially along at least a portion of the spindle unit, is movable axially relative to the spindle, and is held on at least a part of the spindle unit, and is configured for being rotated relative to the spindle;
a measuring attachment;
a measuring device, wherein one of:
(a) the measuring attachment is configured for a distance measurement and is attached to the spindle between the drive side and the head side; and
the measuring device is configured for the distance measurement and interacting with the measuring attachment and is mounted to the reference structure between the head side of the spindle and the measuring attachment; and
(b) the measuring device is configured for the distance measurement and is mounted on the spindle between the drive side and the head side; and
the measuring attachment is configured for the distance measurement and interacting with the measuring device, and is mounted to the reference structure between the head side of the spindle and the measuring device; and
a spacer element, which is in addition to the reference structure or is formed with the reference structure, the spacer element being configured for being placed on a screw base; and
a screwdriver drive configured for driving at least one of the spindle of the screwdriving tool head;
threading the screw, if possible, in such a way that, when the spacer element is in place, the screwdriving device accommodated on the head side of the spindle is applied to the screw head such that the screwdriving device is in a joint state with the screw head;
checking one of:
(a) whether the screwdriving device is in the joint state with the screw head by way of the measuring device attached to the reference structure and configured for the distance measurement and interacting with the measuring attachment attached to the spindle; and
(b) whether the screwdriving device is in the joint state with the screw head by way of the measuring attachment attached to the reference structure and configured for the distance measurement and interacting with the measuring device attached to the spindle; and
screwing in the screw with the screwdriving tool, wherein the screwing in of the screw occurs only if the distance measurement confirms that the screwdriving device that is accommodated on the head side of the spindle is in the joint state with the screw head.

19. The method according to claim 18, wherein the steps of threading, checking, and screwing are carried out by way of a computer program product, when the computer program product is implemented using the screwdriving tool.

20. The method according to claim 18, wherein the screwdriving tool is an automated screwdriving machine, a semi-automatic screwing device, or an automatic screwing device.
